(19) United States
(12) Patent Application Publication
(10) Pub. No.: US 2019/0202231 A1
(43) Pub. Date: Jul. 4, 2019

(54) Paul Paint Can Holder

(71) Applicant: Miguel A. Silva, Peyton, CO (US)

(72) Inventors: Paul C. Nogle, Peyton, CO (US); Miguel A. Silva, Colorado Springs, CO (US)

(21) Appl. No.: 15/859,446

(22) Filed: Dec. 30, 2017

(51) Int. Cl. B44D 3/14

(52) U.S. Cl. CPC B44D 3/14

(57) ABSTRACT

This present clip invention is a means of holding a G/M 231 cubic inch US gallon (3.78 Liter) paint can with control by one hand, leaving the other hand available to perform the art of brush painting. This is attained by clipping one of the four hook positions of the clip to the bail of the paint can in a downward position, and then the thumb is placed on the thumb rest of the clip applying downward pressure to the bail, and then the four fingers on the same hand are placed under the paint can creating a cradle effect producing a controlling hold of the paint can, also providing clear rim access to the paint in the open paint can for the performer of the art of brush painting.

### BACKGROUND OF INVENTION

This clip invention is a means of holding a 231 cubic inch US gallon (3.78 liter) paint can comfortably and with control for an extended length of time. Holding the bail of the paint can is cumbersome during brush painting due to the location of the bail and the wire size of the bail cutting into the fingers from the weight of the can as it hangs from the painters hand. The bail location causes an obstruction for the brush entering and exiting the open paint can due to it being in the middle of the open paint can. To eliminate this obstruction from the bail you can use the thumb to hook the bail and hold it down and place the four fingers of the same hand under the paint can eliminating the obstruction from the bail, but this creates stress on the thumb and can only be performed for a short time. This Paint Can Holder clip is a result of this dilemma. To eliminate the bail obstruction and the weight of the can cutting into the hand from the bail, this clip holds the bail down by clipping onto the bail in a downward position toward the bottom of the paint can, while the four fingers on the same hand are use to create a cradle effect under the can to hold the weight of the can offering full rim access to the paint in the paint can for brush painting. The clip has four hook positions of varying heights to accommodate varying hand sizes at ergonomically comfortable positions, and a flat surface perpendicular to the clip away from the paint can, for the thumb to comfortably rest on, thus maintaining control of the paint can to perform the art of brush painting for longer periods of time.

### SUMMARY OF INVENTION

This invention relates to manually holding a 231 cubic inch US gallon (3.78 liters) pry off lid, paint can. The Paint Can Holder clip comprises of a four position hook system designed to clip onto the bail handle of said paint can, at ergonomically appropriate positions for the painters hand size. There is a through thumb rest continuously molded perpendicular to the third clip opening opposite to the hooks, for the thumb to comfortably rest on while the four fingers of the same hand grasp under the said paint can at the clip location creating a cradle with the hand for the said paint can to rest on, as the open said paint can is held with the hand by the clip attached to the bail the said paint can easily be held for long periods of time, while the art of brush painting is proceeding.

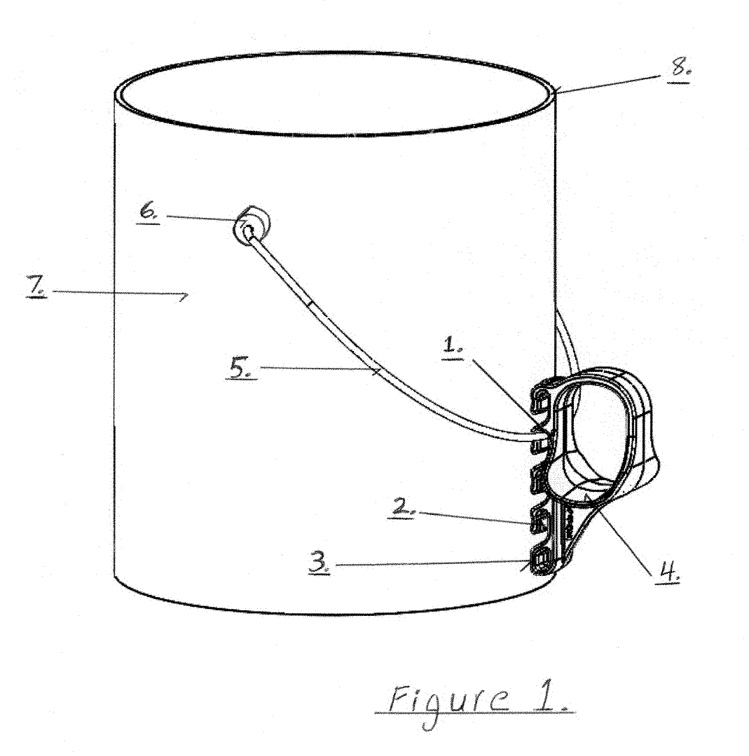

### BRIEF DESCRIPTION OF FIG. 1.

1. The bail hold, 0.119 in. diameter round area for retaining the bail while the clip is in use.

2. The 0.01025 in. opening, portion of the clip leading to the bail hold area.

3. The part of the clip which makes a friction connection, on the perimeter of the paint can creating stability during brush painting.

4. The thumb rest, where the thumb is placed for applying pressure to the clip as it is hooked to the bail, and the four fingers on same hand are placed under the paint can at the clip location to create the hold of the paint can.

5. The 0.104 in. bail wire, of the bail

6. The ear, of the paint can where the bail wire is attached to the paint can.

7. The 231 cubic inch G/M US gallon (3.78 liter) paint can.

8. The rim, of the pry open lid portion of the paint can.

1. (canceled)

2. (canceled)

3. (canceled)

4. (canceled)

5. (canceled)

6. (canceled)
